(19) United States
(12) Patent Application Publication
(10) Pub. No.: US 2011/0175960 A1
(43) Pub. Date: Jul. 21, 2011

(54) LIQUID EJECTION APPARATUS AND LIQUID EJECTION METHOD

(75) Inventor: Yoshiyuki Fukumoto, Kawasaki-shi (JP)

(73) Assignee: CANON KABUSHIKI KAISHA, Tokyo (JP)

(21) Appl. No.: 13/121,272

(22) PCT Filed: Mar. 2, 2010
(86) PCT No.: PCT/JP2010/053721

§ 371 Date: Mar. 28, 2011

(30) Foreign Application Priority Data
Mar. 9, 2009 (JP) 2009-054390

(51) Int. Cl. B41J 29/38

(52) U.S. Cl. 347/14

(57) ABSTRACT

A liquid ejection apparatus comprising a liquid chamber for accommodating a liquid to be supplied from a liquid tank, an ejection port for ejecting droplets of the liquid by applying a pressure to the liquid in the liquid chamber, a pressure application unit for applying the pressure to the liquid in the liquid chamber a liquid-holding structure for holding the liquid on the atmosphere side of the ejection port so as to cover the ejection port with the liquid; and a liquid-removing unit for removing the liquid held on the atmosphere side of the ejection port. The liquid-removing unit controls a timing of ejecting the droplets from the ejection port.

### TECHNICAL FIELD

The present invention relates to a liquid ejection apparatus which converts a liquid agent or the like to fine droplets and ejects the droplets, and a liquid ejection method.

### BACKGROUND ART

There is a method of converting a drug which has been dispersed in a solution (liquid medicine) into micro-droplets and making a patient inhale the micro-droplets, by using an inhaler, as a method of administering the drug to the patient. Such droplets need to reach pulmonary alveoli in particular, in order to deliver the drug to a blood vessel. In order to make such droplets reach the pulmonary alveoli, the droplets need to have diameters of 10 μm at most, desirably of 3 μm approximately. A patient, on the other hand, needs to inhale a large amount of droplets in order to obtain the intended medicinal effect. Accordingly, the inhaler is required to produce a large amount of small droplets to be ejected, in the use for administering a liquid medicine to the blood vessel through inhalation.

As a method for converting a liquid into micro-droplets and ejecting the micro-droplets, there is known a method of applying a high pressure to the liquid, introducing the pressurized liquid to an ejection port of an ejection head, thereby converting the liquid into droplets, and spraying the droplets from the ejection port with the use of the pressure (pressure application system). This type of liquid ejection apparatus includes a pressure application unit such as a pump, a liquid tank for accumulating a liquid therein and an ejection head for ejecting the liquid. The ejection head includes an orifice plate which is a plate having the ejection port and a liquid chamber which retains the liquid therein. The liquid is supplied from the liquid tank to the ejection head, and the liquid medicine is pressurized by a pressure application unit in the ejection head. Then, as the energy due to the pressure of the liquid is converted into a kinetic energy at the ejection port of the ejection head, a liquid column which is a continuous flow of the liquid is formed and ejected from the ejection port. The liquid column is fractured by a wave which has been naturally generated on a side face of the liquid column to form liquid droplets, at a position of the liquid column advanced to some extent from the ejection port.

Japanese Patent No. 3375637 discloses an inhaler which employs such a pressure application system. The inhaler has a structure in which an ejection head and a liquid medicine tank are integrated as a cartridge and the cartridge is made from a material having plasticity. At the time of medication, the inhaler makes a spring to extrude a piston with the power, makes the piston crush one part of the cartridge to generate a strong pressure, and ejects the liquid medicine from the ejection port. In this method, the cartridge is replaced at each time of medication. As the cartridge is disposable, this system is called a single dose system. Contrary to the single dose system, a method of realizing a plurality of medications without changing the cartridge or a head configuration for the method is called a multi-dose system.

An inhaler of the pressure application system has a simple structure, and has an advantage of being capable of freely increasing an ejection quantity. However, the narrower is the ejection port, the larger is the ejection pressure necessary for ejecting the liquid medicine. This is because when the ejection port is narrow, the meniscus pressure due to the surface tension in the ejection port is large and the viscous friction in the ejection port is also large. The ejection pressure to be applied when the liquid medicine is ejected from a fine ejection port of a micrometer order can be 2 MPa or more as is described in Japanese Patent No. 3375637.

As for a printer in other technical fields, a continuous type ink jet printer employs the pressure application system. Japanese Patent Application Laid-open No. H02-036948 describes one example of the continuous type ink jet printer. An ink is pumped up from an ink tank with the use of a pump, then pressurized and transported to the ejection head. The ink is ejected through an ejection port in the ejection head to produce droplets. At this time, an ultrasonic wave is often applied to the inside of the ejection head so as to accurately fracture a liquid column of the ink to produce droplets. An electrode which can generate an electric field and a garter which can collect ejected droplets are provided in front of the ejection port. When the printer is required to make prints, ejected droplets are deflected by the electric field and reaches the surface of the paper. When the printer does not make prints, the above electric field is not applied, and droplets enter into the garter and is returned back to the ink tank. When the printer is used, the droplets are always ejected even when the printer does not make prints on the surface of paper.

A liquid ejection apparatus needs to promptly eject liquid droplets at a desired timing. However, the liquid ejection apparatus of the pressure application system needs a time period (pressurization period of time) necessary for pressurizing a liquid up to the ejection pressure with the use of a pressure application unit. As a result, a time lag is unavoidably caused in between the time when the apparatus has been commanded to eject the droplets and the time when the droplets are actually ejected. In particular, as the diameter of liquid droplets decreases, the ejection pressure increases and accordingly the pressurization period of time also increases.

According to an experiment conducted by the present inventors, the positive pressure necessary for ejecting the droplets having the diameter of 4 μm is as large as 1.9 MPa. In the above description, the ejection pressure is defined as a difference between the ejection pressure and the atmospheric pressure. Note that as the ejection pressure is defined as relative to the atmospheric pressure, the ejection pressure is zero, when the ejection pressure is larger than the atmospheric pressure, the ejection pressure is a positive pressure, and when the ejection pressure is smaller than the atmospheric pressure, the ejection pressure is a negative pressure.

A pump is used as a pressure application unit, and the pressurization period of time was as long as 10 seconds or longer. As the pressurization period of time becomes longer, such a problem occurs more often that the timing of ejecting droplets cannot be accurately anticipated because of a fluctuation of the pressurization period of irregularity of the pressurization period of time. This problem is serious for the liquid ejection apparatus which needs to eject the droplets at accurate timings.

For instance, an inhaler needs to eject droplets at the same time as the timing at which a patient inhales the drug. This is because the time period in which the patient can inhale the droplets at one time is approximately 3 seconds and the inhaler needs to give a required amount of the medicine to the patient in the time period. If the inhaler could not definitely set the timing of ejecting the droplet, the patient will fail in inhalation, inhale a wrong amount of medicine, and not be adequately treated with medication. In addition, if there was a mistake in medication, the liquid medicine would be wasted, which gives an economical loss to the user. In contrast, a continuous type ink jet printer has a mechanism of always ejecting droplets continuously in use, and taking out a necessary amount of droplets when making prints, and accordingly such a problem has not been serious. On the other hand, the liquid ejection apparatus of the pressure application system has an essential requirement of precisely ejecting the droplets at a desired timing, and the solution has been desired.

The inhaler disclosed in Japanese Patent No. 3375637 applies an instant impulsive force generated by the piston provided with a spring to a liquid medicine at a time to eject the liquid medicine in a short pressurization period of time, and accordingly such a problem hardly occurs. However, the pressurization based on the instant impulsive force applies a sudden pressure to the ejection head, and accordingly causes a problem of the durability of the ejection head. A configuration disclosed in Japanese Patent No. 3375637 has the ejection head integrated into a cartridge, and is made for a single dose system. Accordingly, the cartridge can be disposed at each time of medication, and the durability of the ejection head is not a problem. However, in a multi-dose system, the ejection head is repeatedly used several times, and accordingly it becomes a problem from the viewpoint of the durability to shorten the pressurization period of time by such a sudden pressurization.

In addition, it was found from the experiment of the present inventors that the liquid ejection apparatus of the pressure application system causes another problem that a liquid sump is formed on the front face of the ejection port and an error that the droplets cannot be ejected (non-ejection) sometimes occurs even when a user attempts to make the apparatus eject the droplets. When such a non-ejection problem occurs, a large quantity of the liquid results in being wasted and the liquid which has been gathered in the front face of the ejection port needs to be removed. Therefore, a method of surely ejecting droplets in any situations has been desired.

Furthermore, it is picked up as another problem of the liquid ejection apparatus of the pressure application system to waste some quantity of the liquid when the droplets are ejected. This is because the liquid overflows from the ejection port in the pressurization period of time, accordingly it cannot be avoided according to the principle of the pressure application system. A method of preventing such a waste of liquid has been desired.

### DISCLOSURE OF THE INVENTION

An object of the present invention is to provide a liquid ejection apparatus of a pressure application system, which can surely eject a liquid from an ejection port at a desired timing and can reduce a loss of the liquid, which has occurred when the liquid has been ejected, and to provide a liquid ejection method therefor.

According to an aspect of the present invention, there is provided a liquid ejection apparatus comprising: a liquid chamber for accommodating a liquid to be supplied from a liquid tank; an ejection port for ejecting droplets of the liquid by applying a pressure to the liquid in the liquid chamber; a pressure application unit for applying the pressure to the liquid in the liquid chamber; a liquid-holding structure for holding the liquid on the atmosphere side of the ejection port so as to cover the ejection port with the liquid; and a liquid-removing unit for removing the liquid held on the atmosphere side of the ejection port, the liquid-removing unit controlling a timing of ejecting the droplets from the ejection port.

According to another aspect of the present invention, there is provided a liquid ejection method with the use of a liquid ejection apparatus comprising a liquid chamber for accommodating a liquid to be supplied from a liquid tank, an ejection port for ejecting the liquid by applying a pressure to the liquid in the liquid chamber, and a pressure application unit which applies the pressure to the liquid in the liquid chamber, the method comprising: holding a liquid on the atmosphere side of the ejection port so that the liquid covers the ejection port; applying the pressure to the liquid; and ejecting the liquid from the ejection port by removing the held liquid, in this order.

The liquid ejection apparatus according to the present invention can surely eject droplets at a desired timing by controlling the timing of ejecting the droplets with a liquid-removing unit, and can reduce the loss of the liquid, which has occurred when the liquid has been ejected.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIGS. 1A and 1B are views illustrating an ejection head according to a first embodiment, in which FIG. 1A is a plan view and FIG. 1B is a sectional view taken along the line 1B-1B of FIG. 1A.

FIGS. 2A, 2B, 2C, 2D and 2E are process drawings illustrating the procedure in which the liquid is ejected through the ejection head according to the first embodiment.

FIG. 3 is a graph showing a relationship between a pressurization rate and a success percentage of ejection in an ejection head of a pressure application system, which was obtained in an experiment.

FIGS. 4A, 4B and 4C are process drawings illustrating the procedure in which the liquid is ejected through the ejection head according to a second embodiment.

FIG. 5 is a plan view illustrating the ejection head according to a third embodiment.

FIGS. 6A, 6B and 6C are process drawings illustrating the procedure in which the liquid is ejected through the ejection head according to the third embodiment.

FIGS. 7A and 7B are views illustrating the ejection head according to a fourth embodiment, in which FIG. 7A is the plan view and FIG. 7B is the sectional view taken along the line 7B-7B of FIG. 7A.

FIGS. 8A, 8B, 8C and 8D are process drawings illustrating the procedure in which the liquid is ejected through the ejection head according to the fourth embodiment.

FIG. 9 is a schematic view illustrating the whole liquid ejection apparatus according to the fourth embodiment.

FIGS. 10A, 10B and 10C are process drawings illustrating the procedure in which the liquid is ejected through the ejection head according to a fifth embodiment.

FIGS. 11A, 11B, and 11C are process drawings illustrating the procedure in which the liquid is ejected through the ejection head according to a sixth embodiment.

FIG. 12 is a schematic view illustrating an inhaler according to a seventh embodiment.

### BEST MODES FOR CARRYING OUT THE INVENTION

Preferred embodiments of the present invention will now be described in detail in accordance with the accompanying drawings.

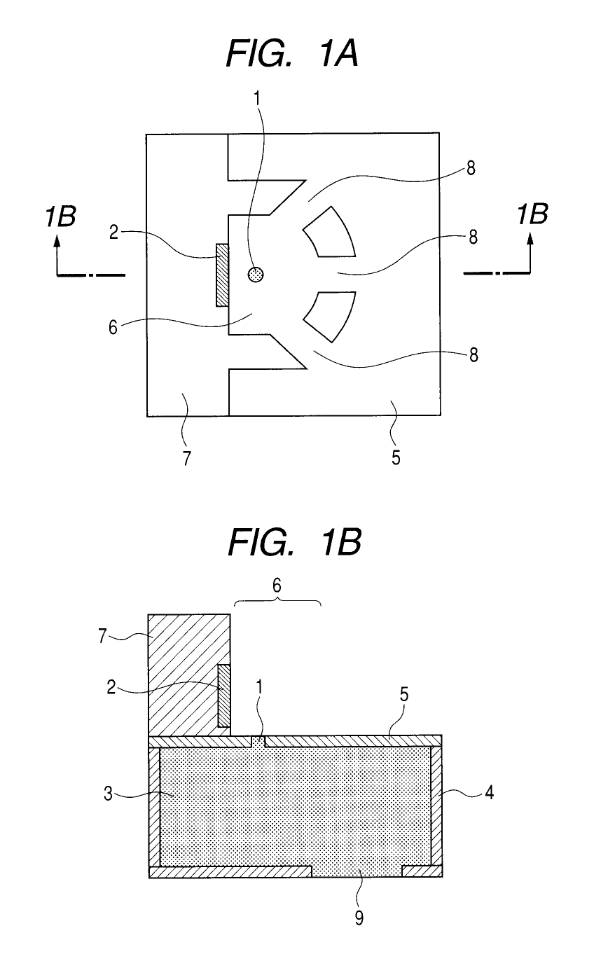

FIGS. 1A and 1B illustrate a main part of a liquid ejection apparatus according to a first embodiment. This liquid ejection apparatus has an ejection port 1, a heater 2 which is a liquid-removing unit for controlling a timing of ejecting droplets from the ejection port 1, a liquid chamber wall 4 constituting a liquid chamber 3 which accommodates the liquid therein, and an orifice plate 5 which forms the upper wall of the liquid chamber 3.

The size of the ejection port 1 which has been formed in the orifice plate 5 is set so as to form a desired size of droplets. In the ejection head of the pressure application system, the diameter of the droplet to be formed by ejection is approximately twice than that of the ejection port. In the application of the inhaler, the diameter of the droplet is required to be 10 to 1 μm, so the diameter of the ejection port can be 0.5 to 5 μm. On the atmosphere side above the ejection port 1, a wall member 7 is formed which is the liquid-holding structure constituting a recessed pond 6. The pond 6 can have a depth in a range of 1 to 10,000 μm so as to be capable of holding a necessary quantity of the liquid therein for inhibiting the droplet from being ejected from the ejection port 1.

In the bottom of the pond 6, the ejection port 1 is arranged, and the heater 2 is arranged in the wall member 7 in the vicinity of the front face of the ejection port. The heater 2 can be a thin film which has electroconductivity but high resistance. For instance, the material can be an oxide, a boride, a nitride or a carbide based on a fine crystalline metal, an amorphous metal or a metal element. Specifically, the material includes AuSi, ZrSi, PdSi, NbSi, Ta, TaN, TaB, TaC, TaNO, HfB, HfN, HfB, HfC, HfNO, ZrN, ZrB, ZrC, ZrNO, Nb, NbN, NbB, NbC and NbNO. The heater 2 is connected to an electric pulse current source, and generates heat when an electric current is passed therethrough. In addition, in a portion which is spaced from the ejection port 1 of the wall member 7 that forms the pond 6, a flowing out channel 8 for the liquid is provided so as to release the liquid.

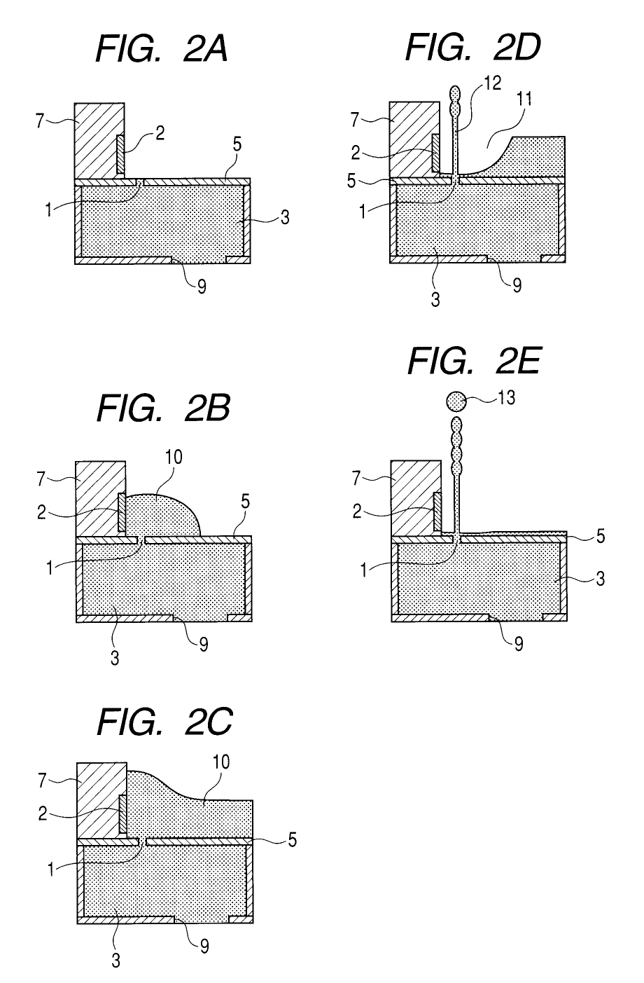

FIGS. 2A to 2E are process drawings illustrating a method for controlling the liquid ejection apparatus in FIGS. 1A and 1B, in other words, a liquid ejection method according to the present invention. A liquid chamber 3 is filled with the liquid which has been supplied from a liquid tank through a communication port 9 when the head is not used (see FIG. 2A). The liquid in the liquid chamber 3 is pressurized by a not-shown pressure application unit, and overflows to the front face (atmosphere side) of the ejection port 1 (see FIG. 2B). After the liquid in the liquid chamber 3 has been pressurized up to the ejection pressure or higher, the pressure of the liquid chamber 3 is kept constant until the ejection will be finished.

The liquid 10 which has been gathered on the front face of the ejection port by the wall member 7 flows in a direction of the flowing out channel 8 for the liquid (see FIG. 2C). In order to appropriately control the quantity of the liquid to be gathered on the front face of the ejection port, the shapes of the pond 6 and the flowing out channel 8 for the liquid are determined in consideration of the shape of and the ejection pressure at the ejection port 1. In this state, the liquid in a quantity of such a level as to inhibit the droplet from being ejected is gathered on the front face of the ejection port 1, so the liquid column cannot be formed out of the ejection port 1 due to the surface tension of the liquid. The quantity of the liquid to be gathered on the front face of the ejection port is decided in consideration of the kinetic energy of the liquid column, which is determined by the ejection pressure and the diameter of the droplet.

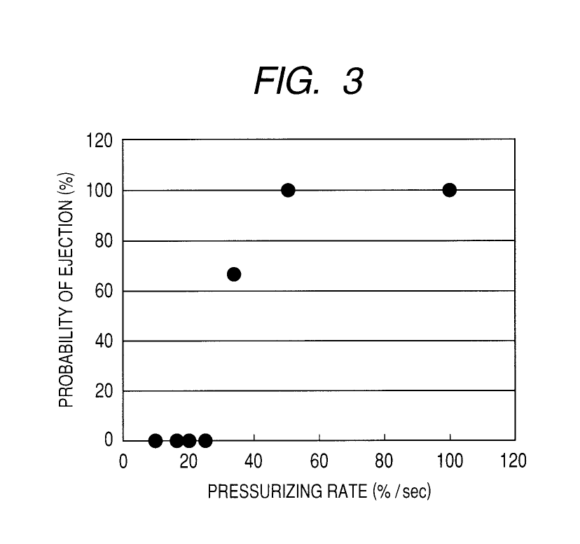

In the pressurization step of FIG. 2B, the pressurization rate (value obtained by dividing the target pressure by the pressurization period of time) needs to be appropriately set. FIG. 3 is a graph showing a relationship between the pressurization rate and the probability at which droplets are normally ejected, which was obtained by the experiment. The experiment was conducted with the use of the ejection head which used the orifice plate made from ruby. The orifice plate had one ejection port therein of which the diameter was 40 μm, and had the thickness of 500 μm. A purified water was used as the liquid. The minimum ejection pressure of this ejection head necessary for ejecting the droplets was 0.07 MPa. The pressurization rate shown in the horizontal axis of FIG. 3 showed the pressure value obtained by dividing this ejection pressure by the pressurization period of time. The ejection probability shown in the vertical axis of FIG. 3 was determined by ejecting the droplets 5 to 10 times on the same condition.

The probability at which the droplets were normally ejected increased by increasing the pressurization rate, and when the pressurization rate became 50% or more of the ejection pressure per second (in this case, 0.035 MPa/sec), the ejection succeeded at the probability of 100%. In addition, an error began to occur at the pressurization rate of 50%/sec of the ejection pressure or less. This is because when the pressurization rate decreased, the liquid was gathered on the front face of the ejection port and the liquid column could not be ejected. Therefore, in order to form the state of FIG. 2C through the ejection procedure according to the present invention, the pressurization rate is set at a low value, and can be set at 50% or less of the ejection pressure per second. Thereby, the liquid is gathered on the front face of the ejection port and the liquid column cannot be ejected.

In the state of FIG. 2C, the heater 2 which is a gas generation unit is energized and heated to generate bubbles in the liquid, at a timing at which the user wants to eject the droplets. The bubbles (gas) 11 are formed by the generation of the bubbles, and all or some parts of the liquid on the front face of the ejection port are removed (see FIG. 2D). As a result, the bonding force of molecules with the liquid which has inhibited the ejection of the liquid column is weakened, and consequently the liquid column 12 is ejected from the ejection port 1. The liquid which has been gathered in the pond 6 is pressed by the original flow and the bubbles 11, and thereby moves to the flowing out channel 8 for the liquid. Then, a state is achieved in which the liquid droplet 13 is regularly generated from the ejection port 1 (see FIG. 2E).

The heater 2 is designed so as to have such a resistance and an area as to be capable of generating the bubbles 11 having an enough power to weaken the bonding force among molecules in the liquid on the front face of the ejection port 1. The heater 2 can control the size and pressure of the bubble 11 by adjusting an electric power to be charged and an energizing period of time. The time period in which the heater 2 needs to be heated is only the time when the liquid on the front face of the ejection port 1 is removed before the droplets are ejected. After the liquid column 12 has been ejected from the ejection port 1, the droplet 13 is kept to be continuously ejected due to the energy of pressure in the liquid chamber 3. In order to also reduce the power consumption of the heater 2, it is desirable to set the quantity of the liquid which has been gathered on the front face of the ejection port in the step shown in FIG. 2C at a necessary minimum value, by optimizing the shape of the pond 6.

When the ejection is finished, the pressure of the liquid in the liquid chamber 3 is decompressed to zero or a negative pressure. Then, the apparatus is stored in a state of filling the liquid chamber with the liquid up to the ejection port 1, as is illustrated in FIG. 2A.

The liquid-holding structure is not limited to the wall member 7 which forms the pond 6, but may have any structure as long as the structure can stably gather the liquid on the atmosphere side of the ejection port. For instance, even the case is effective for the liquid-holding structure, in which a huge liquid sump sticks on a plain orifice plate having no structure provided thereon by gravity or an intermolecular force.

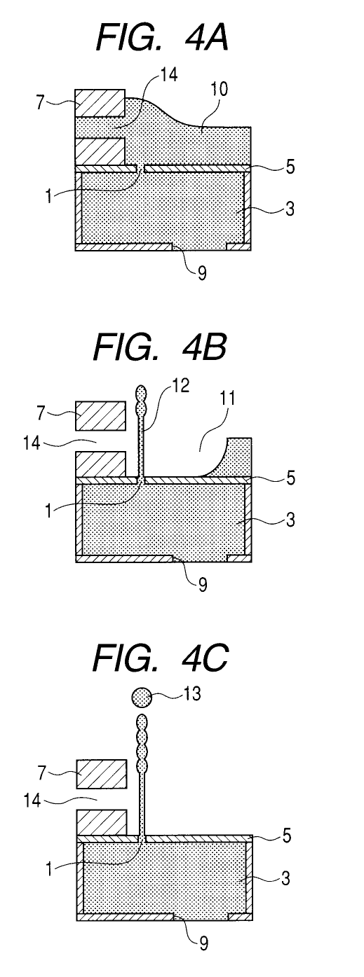

FIGS. 4A to 4C illustrate a main part of a liquid ejection apparatus according to a second embodiment. The liquid ejection apparatus includes a not-shown tank that is a gas generation source for generating a high-pressure compression gas, and a gas-spouting port 14 that is a gas generation unit and is provided in a wall member 7 constituting a pond 6 on the front face of the ejection port so as to be connected to the above tank, which work as a liquid-removing unit.

FIG. 4A illustrates a state right before the liquid-removing unit is driven. A liquid chamber 3 is kept at a pressure of the ejection pressure or higher. The pond 6 is filled with the liquid, and the liquid forms a flow from the liquid chamber 3 toward a flowing out channel 8 for the liquid. FIG. 4B illustrates a state in which the liquid ejection apparatus has made a gas-spouting port 14 connected to the tank spout a gas therethrough, made the gas blow out the liquid on the front face of the ejection port 1 toward the flowing out channel 8 for the liquid, and has started the ejection. In order to smoothly remove the liquid, the gas-spouting port 14 can be provided so as to be capable of spouting the gas in a direction toward the flowing out channel 8 for the liquid. The type of the gas includes air, nitrogen, and an inert gas such as argon. The gas can be oxygen in consideration that when the liquid ejection apparatus according to the present invention is applied to an inhalation apparatus, a patient inhales the medicine. A gas pressure which is sufficiently effective for removing the liquid can be in a range of 0.001 to 0.5 MPa.

In the above described first and second embodiments, the liquid-removing unit employs the gas generation unit of generating a gas. The gas generation unit is superior in the points of being capable of efficiently removing the liquid from the front face of the ejection port and promptly removing the liquid without damaging head parts such as an orifice plate. Out of them, the heater in the first embodiment is particularly superior because of being capable of selectively removing only the liquid on the front face of the target ejection port, easily miniaturizing and simplifying the structure, and being operated at high speed.

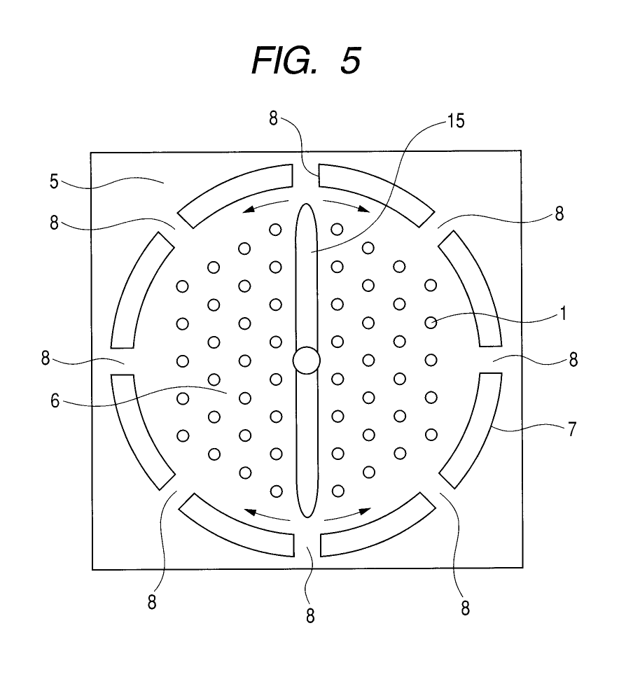

FIG. 5 illustrates a main part of the liquid ejection apparatus according to a third embodiment. In the present embodiment, a wiper 15 which is a mechanically mobile member is used as a liquid-removing unit. The wiper 15 is formed of a bar-shaped or plate-shaped member, and can be slid, rotated or the like.

The bar-shaped wiper 15 is provided on an orifice plate 5, and can be freely rotated on a surface parallel to the orifice plate 5 by a driving unit such as a motor, a gear and a shaft. A wall member 7 constituting the peripheral wall of a circular pond 6 has a flowing out channel 8 for the liquid at a space in the peripheral direction. The wiper 15 is provided in the pond 6 and can sweep most spaces of the pond 6 when being driven. There is a plurality of ejection ports 1 in the bottom of the pond 6. The wiper 15 can be structured so as not to come in contact with the orifice plate 5, in order not to damage the orifice plate 5.

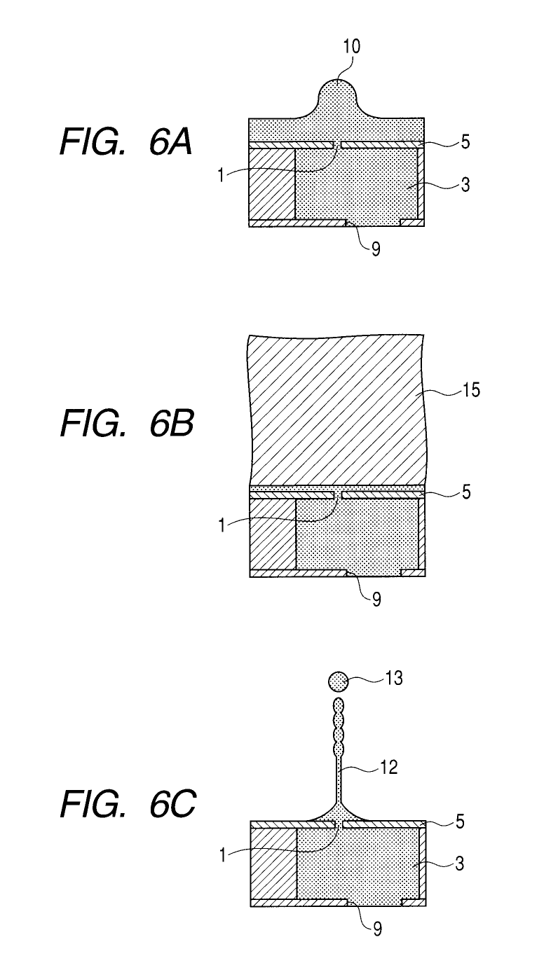

FIGS. 6A to 6C are process drawings illustrating the procedure of ejecting a liquid in the liquid ejection apparatus according to the third embodiment. The liquid ejection apparatus pressurizes a liquid chamber 3 to make the liquid overflow to the pond 6 on the orifice plate 5. The pressure of the liquid chamber 3 is increased to the ejection pressure or higher. In the state before the wiper 15 is driven (see FIG. 6A), the wiper 15 is driven at the timing when ejection is desired. The wiper 15 rotates, works so as to sweep the liquid on the front face of the ejection port 1 (see FIG. 6B), thereby partially removes the liquid, and makes the liquid ejected from the ejection port 1 (see FIG. 6C).

The wiper 15 can have properties of easily adsorbing the liquid thereon when having come in contact with the liquid. For the purpose, the wiper 15 may be covered with a hydrophilic film, or may have a member made from such an absorbent as to absorb the liquid.

The liquid ejection apparatus may have one wiper to remove the liquid on the front faces of all the ejection ports as in the present embodiment, or may have wipers independently on each of the ejection ports.

Alternatively, the liquid ejection apparatus may have a structure in which the wall member 7 itself constituting the pond 6 functions as a wiper which is a mobile member, slides in parallel to the orifice plate surface and removes the liquid.

Other liquid-removing units than those illustrated in the above may include a unit of generating an ultrasonic wave with a piezoelectric element or the like and remove the liquid.

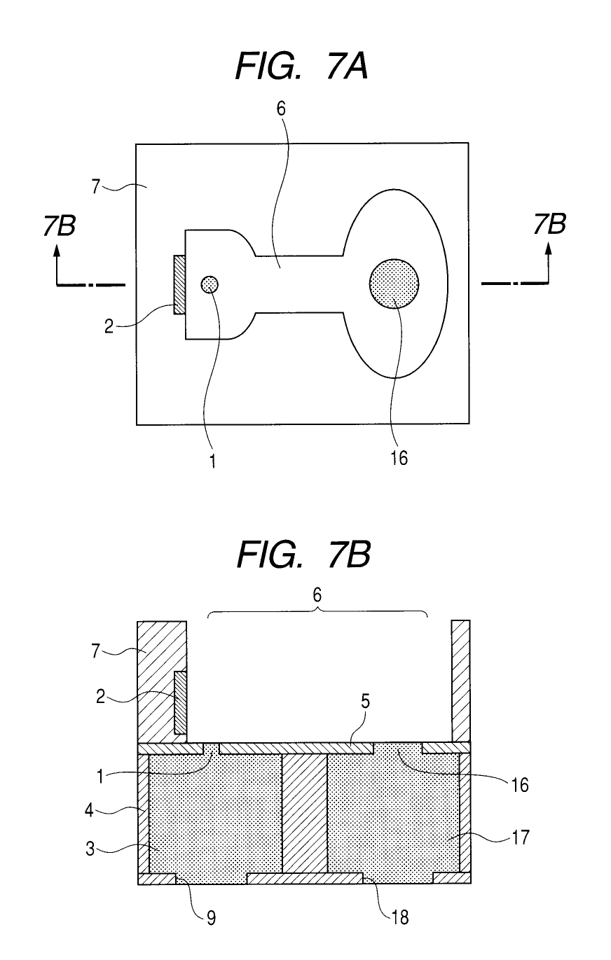

FIGS. 7A and 7B illustrate a main part of a liquid ejection apparatus according to a fourth embodiment.

In the first to third embodiments, the liquid which has overflowed from the ejection port 1 was only gathered on the pond 6 that is a space for holding the liquid therein. However, the liquid ejection apparatus according to the present embodiment has a collection port which leads to the liquid tank provided therein and makes the pond 6 communicated with the collection port to collect the liquid that has overflowed at the time of the ejection without wasting the liquid.

FIG. 7A is a plan view illustrating a main part of the liquid ejection apparatus according to the present embodiment, and FIG. 7B is a sectional view taken along the line 7B-7B of FIG. 7A. The collection port 16 is provided on an orifice plate 5 so as to face a pond 6 in addition to an ejection port 1. The liquid-removing unit employs a heater 2 similarly to that in the first embodiment. The liquid which has overflowed from the ejection port 1 flows on the orifice plate 5, and is returned into an ejection head through the collection port 16. The ejection head has separately both of a first liquid chamber 3 provided in an ejection side, which communicates with the ejection port 1, and a second liquid chamber 17 provided in a collection side, which communicates with the collection port 16. The liquid flows in through the communication port 9 which communicates with the liquid chamber 3 in the ejection side, and flows out through the communication port 18 which communicates with the liquid chamber 17 in the collection side.

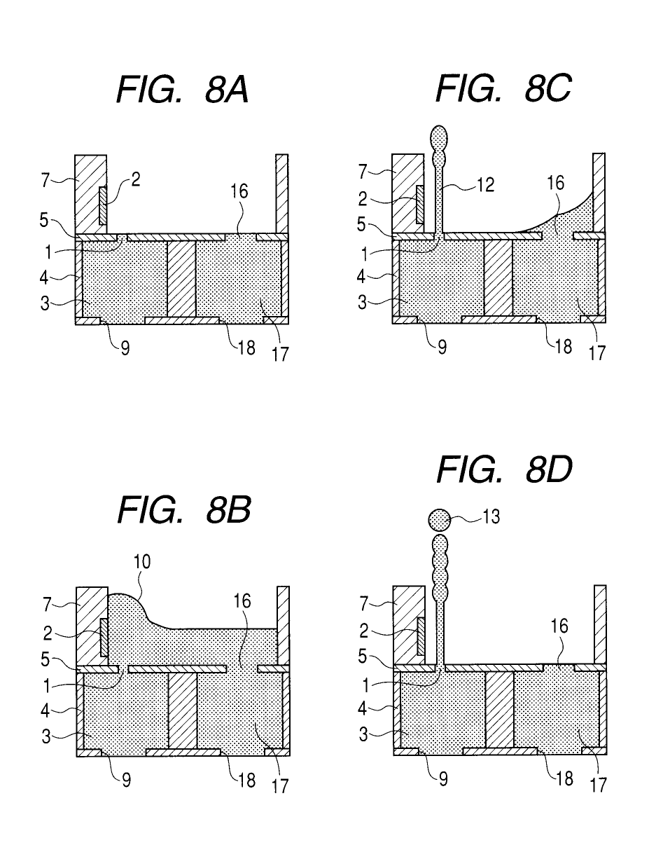

FIGS. 8A to 8D illustrate the ejection procedure of the liquid ejection apparatus according to the present embodiment. FIG. 8A illustrates a state before the ejection starts (state of being stored), in which tanks in tank sides of a border formed by the ejection port 1 and the collection port 16 are all filled with the liquid. A negative pressure of approximately 0.1 to 100 kPa is applied to the liquid, and the liquid does not overflow onto the surface of the orifice plate 5 and is stably held by the meniscuses at the ejection port 1 and the collection port 16.

FIG. 8B illustrates a state at the time when the liquid has been pressurized up to the ejection pressure. The liquid column is not ejected from the ejection port 1, but flows out from the ejection port 1, flows into the collection port 16 through the pond 6, and finally returns to the liquid tank.

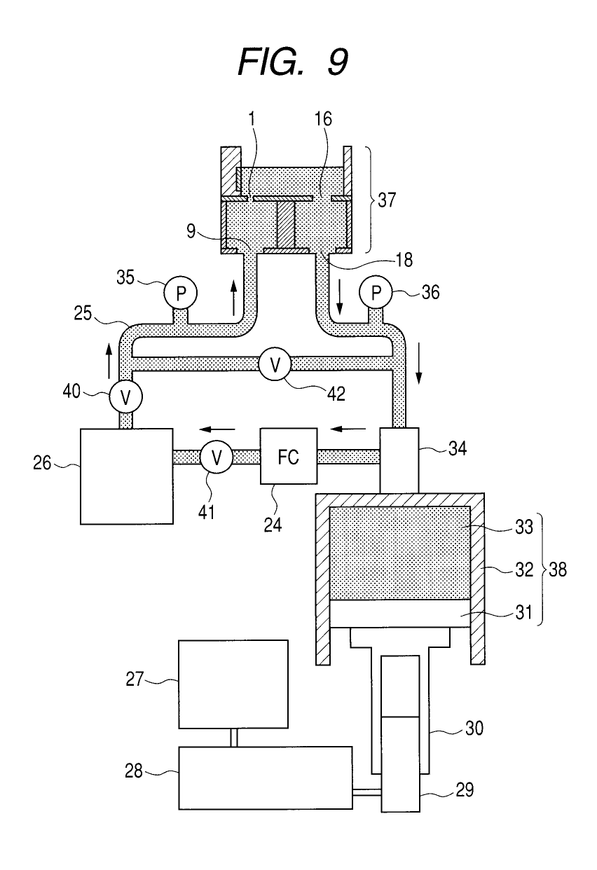

FIG. 9 illustrates a configuration of the whole liquid ejection apparatus at the time. The liquid ejection apparatus is in a state in which a first valve 40 and a second valve 41 are opened and a third valve 42 is closed. The liquid is transported to the pump 26 from the liquid tank cartridge 38 and is sent to the ejection head 37. Afterward, the liquid that has overflowed from the ejection port 1 is returned again to the liquid tank cartridge 38 from the ejection head 37 through the collection port 16. The pressure application unit is a pump 26, and the pump 26 pressurizes the liquid in a flow channel between the pump 26 and the ejection port 1, up to an ejection pressure. Right before ejection starts, the liquid circulates in the liquid ejection apparatus, and the pond 6 is filled with the liquid.

At this time, a negative pressure can be applied to the liquid in the flow channel between the atmosphere side of the ejection port 1 and the liquid tank cartridge 38 so that the liquid flows into the collection port 16. When a gear pump or the like is employed as the pump 26, the pump 26 can apply a negative pressure to the collection port side while applying a positive pressure to the ejection port 1 side. In this case, the pressure value in each place of the liquid flow channel in which the liquid circulates can be controlled by a flow rate control unit 24 or the like.

A liquid tank cartridge 38 which can control the pressure with a piston mechanism is illustrated in FIG. 9, as a unit of more precisely controlling a negative pressure in the flow channel between the atmosphere side of the ejection port 1 and the liquid tank cartridge 38. The liquid tank cartridge 38 includes a liquid container (container) 32 and a lid member 31, and the lid member 31 is structured to be capable of sliding in the container 32.

A gap between the lid member 31 and the container 32 is sealed so that the liquid does not leak therethrough. The lid member 31 is connected to a reciprocatable piston 30. The hole formed in the piston 30, in which a spiral groove is engraved, is engaged with a screw of the shaft 29. The shaft 29 is connected to a motor 27 through a gearbox 28. The liquid ejection apparatus controls the pressure of the liquid in the flow channel between the liquid cartridge and the atmosphere side of the ejection port 1, by rotating the motor 27, thereby rotating the shaft 29, and moving the piston 30 and the lid member 31 back and forth. The liquid ejection apparatus can pressurize the liquid by pressing the piston 30, and can decompress the liquid by pulling the piston. When the liquid is exchanged, the cartridge is exchanged by disconnecting the shaft 29 with the lid member 31.

In order to precisely control this negative pressure, an additional second pump may be provided instead of the piston mechanism illustrated in FIG. 9. A negative pressure desirable for the liquid can be easily applied to the liquid by using the second pump. Even in the first to third embodiments, a negative pressure smaller than the atmospheric pressure may be applied to the liquid which is held by a liquid-holding structure, by such a negative-pressure generation unit. In the case, the liquid can easily move from the ejection port to the side of the flowing out channel 8 for the liquid. This is because if the liquid did not move, the liquid might not be sufficiently removed from the front face of the ejection port. In addition, a flow rate control unit 24 can control the flow rate of the liquid which flows through the flow channel, and can precisely control the pressure in the vicinity of the liquid tank cartridge 38.

When ejecting the liquid, the liquid ejection apparatus energizes the heater 2 to generate bubbles 11, and removes the liquid 10 which covers the ejection port 1. As a result, the droplets are ejected from the ejection port 1 (see FIG. 8C). The liquid having existed on the front face of the ejection port 1 is collected through the collection port 16, and the flow of the liquid stops due to the meniscus of the liquid formed at the collection port 16 (see FIG. 8D). The liquid ejection apparatus may further increase the negative pressure for collecting the liquid to empty the liquid chamber 17 of the collection side.

When finishing ejection, the liquid ejection apparatus decreases the positive pressure of the liquid in the liquid chamber 3 down to a negative pressure by opening the third valve 42. Finally, the liquid ejection apparatus stops the pump 26, closes the first valve 40 and the second valve 41, then desirably controls the pressure of the whole liquid to a negative pressure of approximately 0.1 to 100 kPa, and is stored in a state of FIG. 8A.

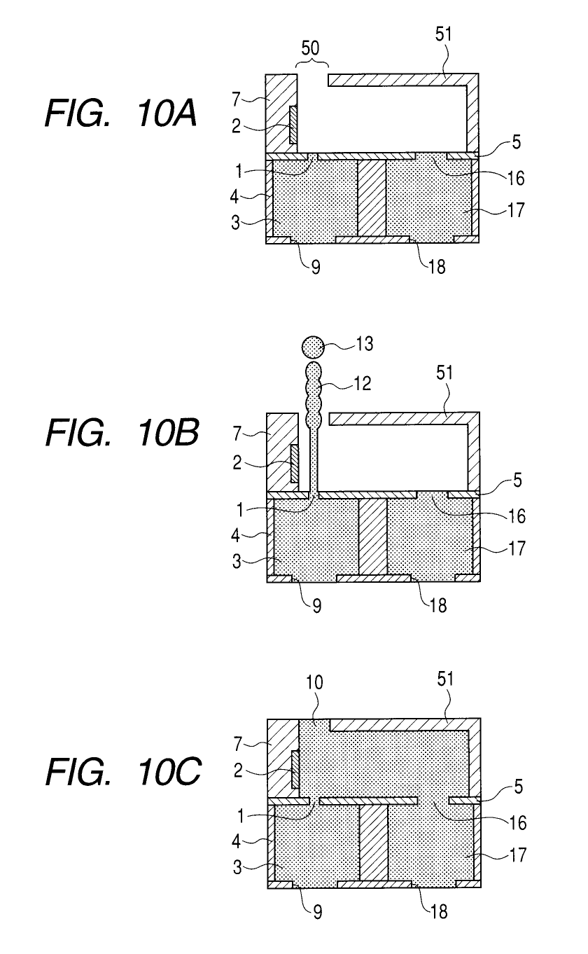

FIGS. 10A to 10C illustrate a main part of a liquid ejection apparatus according to a fifth embodiment.

The liquid ejection apparatus according to the present invention is characterized in that the apparatus prepares a flow of the liquid toward the atmosphere side from the ejection port when ejecting the liquid. In the first to fourth embodiments, the flow of the liquid is exposed to the atmosphere, but the liquid ejection apparatus in the present embodiment is structured so as to cover the liquid which flows in the front face of the ejection port 1 with a shielding member 51 having an aperture 50. The shielding member 51 has the aperture 50 which opposes to the ejection port 1, and almost all of the liquid which has overflowed from the ejection port 1 are covered with the shielding member 51, and may not spread to the outside of the ejection head.

The shielding member 51 may be any member as long as the member can sufficiently shield the liquid from the atmosphere. The shielding member 51 also can keep the liquid clean. A space in an atmosphere side of an orifice plate 5 is covered with the shielding member 51, and the liquid 10 is held in a hollow part surrounded by the orifice plate 5 and the shielding member 51.

The aperture 50 which opposes to the ejection port 1 needs to make at least the liquid column which has been ejected from the ejection port 1 pass therethrough so that the liquid column does not collide against the shielding member 51. Therefore, the aperture 50 needs to have a larger area than the ejection port 1. When the shapes of the ejection port 1 and the aperture 50 are circles, the diameter of the aperture needs to be larger than the diameter of the ejection port.

FIG. 10A illustrates the ejection head at the time of being stored. The liquid chamber sides of both of the ejection port 1 and the collection port 16 are filled with the liquid. When the positive pressure is applied to the liquid chamber 3 in the ejection side and the negative pressure is applied to the liquid chamber 17 in the collection side similarly to the operation in FIG. 8B, the flow of the liquid direction toward the collection port 16 from the ejection port 1 is generated in the hollow part. In this state, when the liquid on the front face of the ejection port is removed by the heater 2 of the liquid-removing unit, the generated liquid column 12 or the droplet 13 passes through the aperture 50 of the shielding member 51, and is ejected to the outside (see FIG. 10B). When the ejection is finished, the liquid chamber 3 in the ejection side is promptly decompressed to a negative pressure. When the liquid chamber 3 in the ejection side and the liquid chamber 17 in the collection side are held at an adequate negative pressure, the liquid is all returned to the state in which the liquid is collected in both of the liquid chambers (see FIG. 10A).

After the ejection has been stopped, the liquid ejection apparatus may be stored in a state of having applied a slightly positive pressure to both of the liquid chambers 3 and 17, having filled the hollow part up to the aperture 50 with the liquid as is illustrated in FIG. 10C, having formed the meniscus in the aperture 50, and then having kept both of the liquid chambers 3 and 17 at a pressure of zero or a negative pressure of approximately 0.1 to 100 kPa. In the case, the ejection port 1 can be prevented from clogging due to the drying of the solution.

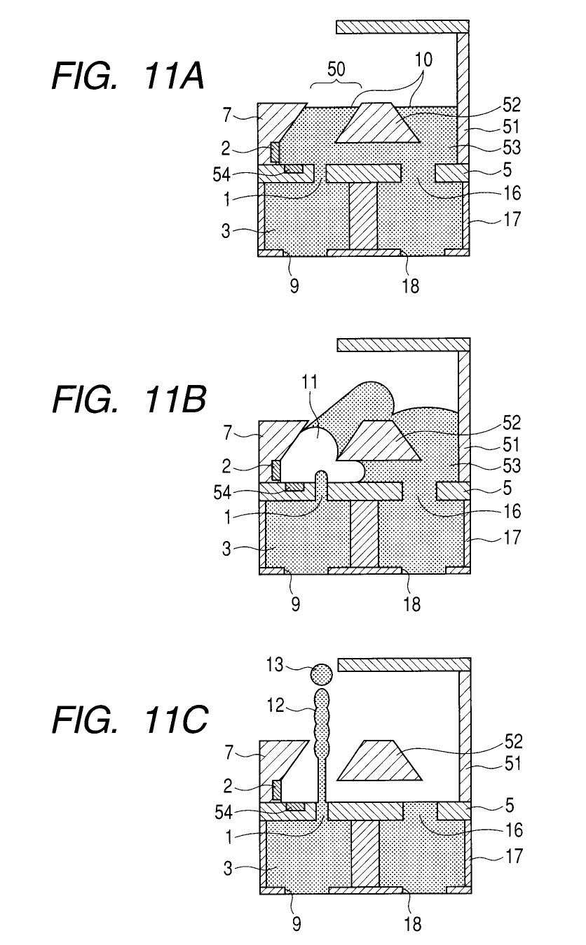

FIGS. 11A to 11C illustrate a main part of a liquid ejection apparatus according to a sixth embodiment. In the fifth embodiment, when the liquid is ejected, one part of the liquid is ejected to the atmosphere side through an aperture 50 by a liquid-removing unit. As a result, an undesired liquid may be ejected, which causes the waste of the liquid. The liquid ejection apparatus according to the present embodiment has such a configuration as to be capable of solving the problem, and has the same structure as that of FIGS. 10A to 10C except a structure on the atmosphere side of the orifice plate 5. FIG. 11A illustrates a state of the ejection head which has pressurized the liquid chamber 3 in an ejection side, has decompressed the liquid chamber 17 in a collection side, but does not drive the liquid-removing unit yet. A guiding member 52 for guiding the liquid is provided in the aperture 50, and a flow channel 53 from the guiding member 52 reaching the collection port 16 to enable the liquid 10 to be collected.

The liquid-removing unit includes a first heater 2 and a second heater 54 so that a removed liquid collides against the guiding member 52. The heaters are arranged so as to be capable of blowing the liquid 10 from the aperture 50 toward an oblique direction with respect to a direction in which the droplets are ejected.

FIG. 11B illustrates an ejection head right after the liquid-removing unit has been driven. Bubbles 11 which have been formed by two heaters 2 and 54 expand to the oblique direction, and lead some liquid which has covered the ejection port 1, in a direction different from a direction of ejecting droplets at the ejection port 1, by the guiding member 52. The liquid column starts to be ejected from the ejection port 1. The extruded liquid collides against the guiding member 52, and then passes through the flow channel 53 to be collected from the collection port 16.

FIG. 11C illustrates an ejection head at the time when droplets are ejected. The liquid on the orifice plate 5 is all collected from the collection port 16. When stopping the ejection, the liquid ejection apparatus decompresses the liquid chamber 3 in the ejection side down to an appropriately positive pressure and stops the ejection of the liquid column 12. The liquid chamber 3 has a positive pressure, so the liquid overflows from the ejection port 1. When the overflowed liquid forms the meniscus on the aperture 50, the liquid chamber 3 in the ejection side and the liquid chamber 17 in the collection side are decompressed to the same negative pressure to form a state illustrated in FIG. 11A. The liquid ejection apparatus may be stored in a state of having collected all the liquid on the atmosphere side s of both the ejection port 1 and the collection port 16 into the ejection head, as is illustrated in FIG. 11A.

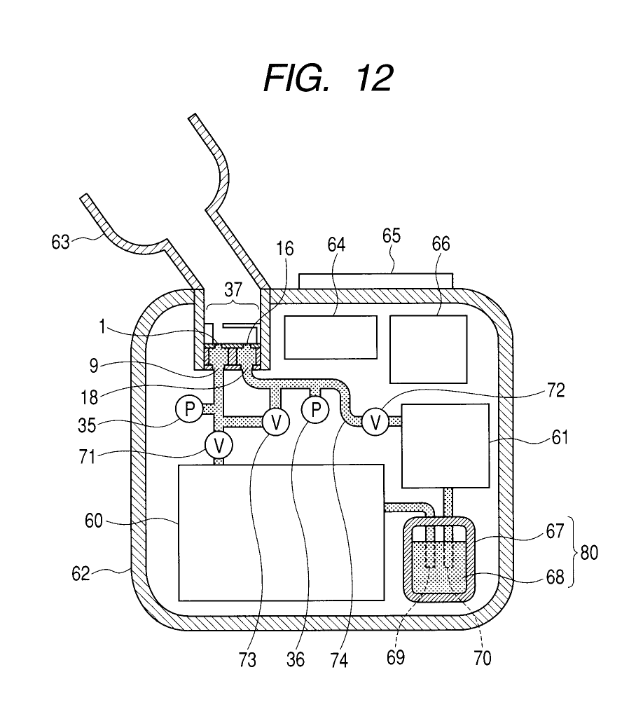

FIG. 12 illustrates an inhaler according to a seventh embodiment. In a housing 62 of the apparatus, there exist a liquid medicine tank 67 for storing a liquid medicine therein, a first pump 60 which is a pressure application unit, an ejection head 37, and a second pump 61 which is a negative-pressure generation unit, and the parts are connected through tubes and valves. An ejection head 37 is the ejection head illustrated in the fifth embodiment. Furthermore, pressure sensors are attached at important points. The first pump 60 pressurizes the liquid in the flow channel from the first pump 60 to the ejection port 1, and the second pump 61 applies a negative pressure to the liquid in the flow channel ahead of the ejection port 1. The inhaler also includes a control circuit unit 64 and a power source section 66, and the unit controls the operation in each part. The display/interface section 65 is provided on the upper surface of the housing 62. The display/interface section 65 includes various switches for operating the inhaler, and a display for displaying the state of the inhaler and the medication information. A user operates the switches while watching the display to operate the inhaler. The droplets are sprayed from an inhalation pipe 63 (mouth piece or nose piece) which is provided on the front face of the ejection head 37 and projects from the housing 62. The patient can inhale the droplets by approaching her/his face to the inhalation pipe 63 and inhaling the ejected liquid medicine.

The operation procedure for the user and the operation of each unit when this inhaler is used will now be described below. All valves in the inhaler are closed in a stored state in which the power source is turned off. The user turns the power source on, sets the medication quantity on the display/interface section 65, and pushes a standby switch. When the standby switch is pushed, the first pump 60 starts to work, the first valve 71 and the second valve 72 are opened, and the first pump 60 pumps up the liquid medicine from the liquid medicine tank and extrudes the liquid medicine to the ejection head 37 side. Then, the medicine liquid in the flow channel from the first pump 60 to the ejection port 1 starts to be pressurized. The second pump 61 also starts its operation, and the liquid in the flow channel from the ejection port 1 on the atmosphere side to the second pump 61 starts to be decompressed. The control circuit unit 64 monitors the pressure in each portion of the flow channel with pressure gauges 35 and 36, and appropriately controls the speed of the pressurization and decompression, and the flow rate of the liquid. The liquid medicine which has been sucked by the pump is returned to the liquid medicine tank 67.

When the inside of the ejection head 37 is pressurized to the ejection pressure or higher and the liquid medicine turns into a state of circulating in the flow channel of the liquid medicine in the inhaler, the standby lamp of the display/interface section 65 lights up. In this state, the inhaler can generate droplets at any time. The user approaches her/his face to the inhalation pipe 63, presses an inhaler start button, and simultaneously starts to inhale. When the inhale start button is pressed, the heater 2 of a liquid-removing unit generates bubbles 11 at the front face of the ejection port 1, and removes the liquid medicine on the front face of the ejection port 1. The droplets start to be ejected. The droplets are ejected only for the ejection period of time determined by ejection quantity. The user continues to inhale the medicine until the ejection of the droplets stops after the ejection has started. When the ejection is finished, the first pump 60 stops and a third valve 73 is opened. As a result, the pressure in the ejection head 37 suddenly decreases and the ejection stops. The liquid medicine between the ejection head 37 and the second pump 61 is decompressed down to a negative pressure by the second pump 61. When the pressure in the ejection head 37 has reached the negative pressure value optimal for a storage state, the second pump 61 stops and all valves are closed. Then, the inhaler becomes a state of being stored.

When using the inhaler of the pressure application system of the present embodiment, the user can precisely control a timing of ejection, does not need to worry about non-ejection originating from the wetting of the liquid, and can surely inhale an accurate medication quantity of the medicine. Furthermore, the inhaler does not waste the medicine at the time of the inhalation operation compared to conventional inhalers of a pressure application system.

The liquid ejection apparatus according to the present invention can be applied not only to the inhaler but also to a wide range of equipment to which a liquid ejection apparatus of a pressure application system is applied. The liquid to be ejected includes a liquid medicine, a purified water, an aromatic solution, ethanol, an ink, a solution of a functional organic substance and a solution of a functional metal.

The liquid ejection apparatus according to the present invention can be applied to a humidifier, a smell generator, a printer, a mist generator and an apparatus for manufacturing an electron device (display, wiring board and the like), in addition to the inhaler. The liquid ejection apparatus according to the present invention can promptly and surely eject a liquid at a desired timing compared to a conventional liquid ejection apparatus. These advantages are remarkable particularly when fine droplets are ejected. In addition, there is a further advantage that a conventionally wasted liquid in ejection can be reduced.

The present invention is not limited to the above embodiments and various changes and modifications can be made within the spirit and scope of the present invention. Therefore to apprise the public of the scope of the present invention, the following claims are made.

This application is based upon and claims the benefit of priority from Japanese Patent Application No. 2009-054390, filed on Mar. 9, 2009, which is hereby incorporated by reference herein in its entirety.

1. A liquid ejection apparatus comprising:
a liquid chamber for accommodating a liquid to be supplied from a liquid tank;
an ejection port for ejecting droplets of the liquid by applying a pressure to the liquid in the liquid chamber;
a pressure application unit for applying the pressure to the liquid in the liquid chamber;
a liquid-holding structure for holding the liquid on the atmosphere side of the ejection port so as to cover the ejection port with the liquid; and
a liquid-removing unit for removing the liquid held on the atmosphere side of the ejection port,
the liquid-removing unit controlling a timing of ejecting the droplets from the ejection port.

2. The liquid ejection apparatus according to claim 1, wherein the liquid-removing unit removes the liquid which covers the ejection port, in a state in which the pressure application unit applies a minimum ejection pressure necessary for ejecting the droplets from the ejection port or higher pressures to the liquid in the liquid chamber so that the apparatus ejects the droplets from the ejection port.

3. The liquid ejection apparatus according to claim 2, wherein the pressure application unit pressurizes the liquid in the liquid chamber at a pressurization rate of 50% or less of the minimum ejection pressure per second.

4. The liquid ejection apparatus according to claim 1, wherein the apparatus continuously ejects the droplets from the ejection port by pressurizing the liquid with the pressure application unit and maintaining the pressurized pressure.

5. The liquid ejection apparatus according to claim 1, wherein the apparatus has a negative-pressure generation unit for applying a negative pressure lower than the atmospheric pressure to the liquid held in the liquid-holding structure.

6. The liquid ejection apparatus according to claim 1, wherein the liquid-removing unit includes a gas generation unit which generates a gas so that the gas generated in the gas generation unit removes the liquid held on the atmosphere side of the ejection port.

7. The liquid ejection apparatus according to claim 6, wherein the gas generation unit includes a heater which generates heat by energization so that a bubble generated by the heat of the heater removes the liquid held on the atmosphere side of the ejection port.

8. The liquid ejection apparatus according to claim 6, wherein the gas generation unit includes a gas-spouting port to be connected to a gas generation source so that the liquid held on the atmosphere side of the ejection port is removed by spouting the gas from the gas-spouting port.

9. The liquid ejection apparatus according to claim 1, wherein the liquid-removing unit includes a wiper provided on the atmosphere side of the ejection port so that the liquid held on the atmosphere side of the ejection port is removed by driving the wiper.

10. The liquid ejection apparatus according to claim 1, wherein the liquid-holding structure communicates with a collection port connected to the liquid tank so that the liquid held in the liquid-holding structure is collected from the collection port into the liquid tank.

11. The liquid ejection apparatus according to claim 1, wherein the liquid-holding structure includes a shielding member for shielding the liquid held in the liquid-holding structure from the atmosphere, and the shielding member has an aperture opposed to the ejection port.

12. The liquid ejection apparatus according to claim 11, wherein the aperture has a larger area than the ejection port.

13. The liquid ejection apparatus according to claim 11, wherein the shielding member includes a guiding member which guides the liquid held in the liquid-holding structure toward a direction different from the ejection direction in which the droplets are ejected from the ejection port.

14. An inhaler including the liquid ejection apparatus according to claim 1.

15. A liquid ejection method with the use of a liquid ejection apparatus comprising a liquid chamber for accommodating a liquid to be supplied from a liquid tank, an ejection port for ejecting the liquid by applying a pressure to the liquid in the liquid chamber, and a pressure application unit which applies the pressure to the liquid in the liquid chamber, the method comprising:
holding a liquid on the atmosphere side of the ejection port so that the liquid covers the ejection port;
applying the pressure to the liquid; and
ejecting the liquid from the ejection port by removing the held liquid, in this order.

16. The liquid ejection method according to claim 15, wherein the liquid covering the ejection port is removed, in a state in which a minimum ejection pressure necessary for ejecting the liquid from the ejection port or higher pressures is applied to the liquid in the liquid chamber, to eject the liquid from the ejection port.
